(19) United States
(12) Patent Application Publication
(10) Pub. No.: US 2026/0062896 A1
(43) Pub. Date: Mar. 5, 2026

(54) Water Leak Control System and Device

(71) Applicant: YoSmart Inc., Lake Forest, CA (US)

(72) Inventors: John Xu, Irvine, CA (US); Weilong Zuo, Miluo (CN)

(21) Appl. No.: 19/283,722

(22) Filed: Jul. 29, 2025

Related U.S. Application Data
(60) Provisional application No. 63/688,080, filed on Aug. 28, 2024.

(51) Int. Cl. E03B 7/07; G01M 3/00

(52) U.S. Cl. CPC E03B 7/071; E03B 7/072; G01M 3/00

(57) ABSTRACT

A leak control device includes first and second flow control assembly, each including a flow sensor; a valve assembly with a valve and an actuator; a cable assembly, including a leak detector cable and a leak sensor, such that the leak control device close the valve to stop a flow water through the leak control device, if the leak control device receives a leak indication from the leak sensor or detects a flow anomaly condition in communication with the flow sensor. Also disclosed is a method of installing the leak control device, measuring an actual flow duration of water flow events, measuring an actual flow quantity, measuring an actual daily water usage, and counting an actual number of daily water flow events.

### CROSS-REFERENCE TO RELATED APPLICATIONS

This application claims the benefit of U.S. Provisional Application No. 63/688,080, filed Aug. 28, 2024; which is hereby incorporated herein by reference in its entirety.

### FIELD OF THE INVENTION

The present invention relates generally to the field of device for detecting and preventing water leaks in various water supply systems, including toilets, bathroom sinks, and kitchen sinks, and more particularly to methods and systems for monitoring and control of leaks in a toilet installation and other installations of appliances and devices with a water supply.

### BACKGROUND OF THE INVENTION

Traditional methods of leak detection often require complex installations and professional assistance, making them inaccessible and impractical for many consumers. Additionally, existing solutions may lack the capability to automatically shut off the water supply upon detecting a leak, leading to potential water damage and increased water bills.

As such, considering the foregoing, it may be appreciated that there continues to be a need for novel and improved devices and methods for systems for monitoring and control of leaks.

### SUMMARY OF THE INVENTION

The foregoing needs are met, to a great extent, by the present invention, wherein in aspects of this invention, enhancements are provided to the existing model of leak monitoring and control.

In an aspect, a leak control system can include:
a) A leak control device for leak detection and prevention, wherein the leak control device can include:
   i. a control unit;
   ii. a flow control assembly;
      1) a valve assembly, including:
         an electro-mechanical actuator;
         a valve, which is mechanically connected to the electro-mechanical actuator;
      2) a flow sensor; and
   iii. a leak detector cable, which can be configured with a leak sensor along a length of the leak detector cable, such that the leak sensor can detect a presence of water on a floor surface adjacent to the toilet;
wherein the leak control device can be fluidly connected to a water supply line between an initial segment and a secondary segment of the water supply line, such that the flow sensor can measure a flow of water through the flow control assembly of the leak control device;
wherein the leak control device can be configured to close the mechanical valve, to stop the flow of the water through the leak control device and to the toilet, if the leak control device receives a leak indication from the leak sensor or detects a flow anomaly condition in communication with the flow sensor.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1A is a schematic diagram illustrating a leak control system with a single-valve leak control device, according to an embodiment of the invention.

FIG. 1B is a schematic diagram illustrating a leak control system with a dual-valve leak control device, according to an embodiment of the invention.

FIG. 2 is a schematic diagram illustrating a leak control system including a plurality of single-valve and dual-valve leak control devices, according to an embodiment of the invention.

FIG. 3A is a schematic diagram illustrating a single-valve leak control device, according to an embodiment of the invention.

FIG. 3B is a schematic diagram illustrating a dual-valve leak control device, according to an embodiment of the invention.

FIG. 4 is a schematic diagram illustrating a leak control communication device, according to an embodiment of the invention.

FIG. 5A is a right bottom perspective view of a single-valve leak control device, according to an embodiment of the invention.

FIG. 5B is a left top perspective view of a single-valve leak control device, according to an embodiment of the invention.

FIG. 5C is a front view of a single-valve leak control device, according to an embodiment of the invention.

FIG. 5D is a perspective view of a single-valve leak control device in a partially disassembled configuration, according to an embodiment of the invention.

FIG. 5E is a perspective view of parts of a single-valve leak control device in a partially disassembled configuration, according to an embodiment of the invention.

FIG. 5F is a perspective view of parts of a single-valve leak control device in a partially disassembled configuration, according to an embodiment of the invention.

FIG. 6A is a perspective view of parts of a leak control assembly of a single-valve leak control device in a partially disassembled configuration, according to an embodiment of the invention.

FIG. 6B is a perspective view of parts of a leak control assembly of a single-valve leak control device in a partially disassembled configuration, according to an embodiment of the invention.

FIG. 7A is a right bottom perspective view of a dual-valve leak control device, according to an embodiment of the invention.

FIG. 7B is a left top perspective view of a dual-valve leak control device, according to an embodiment of the invention.

FIG. 7C is a front view of a dual-valve leak control device, according to an embodiment of the invention.

FIG. 7D is a perspective view of parts of a single-valve leak control device with a front shell removed, according to an embodiment of the invention.

FIG. 7E is a perspective view of parts of a single-valve leak control device with a front shell and control boards removed, according to an embodiment of the invention.

FIG. 8 is a flowchart illustrating steps that may be followed, in accordance with one embodiment of a method or process of leak control.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

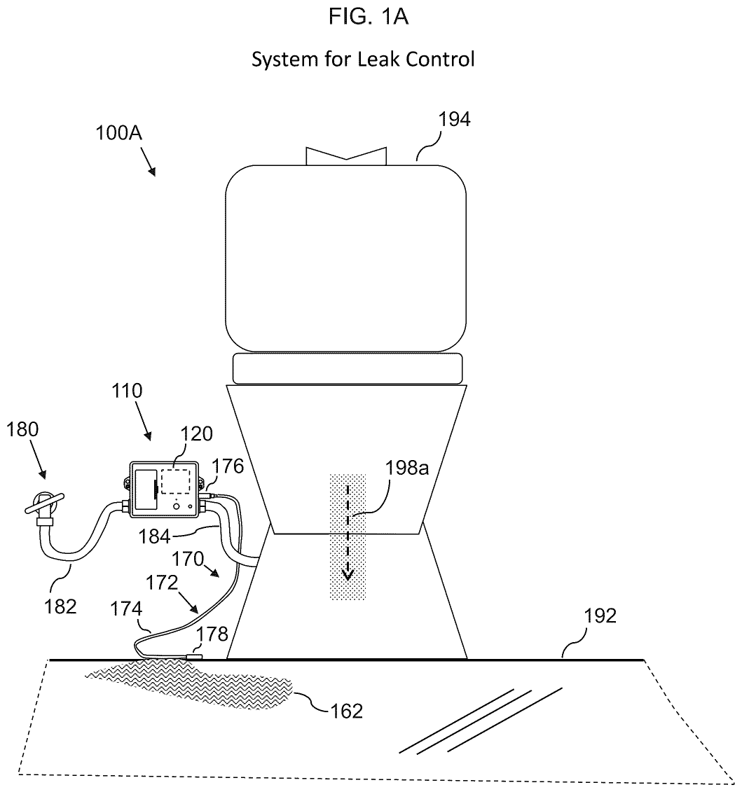

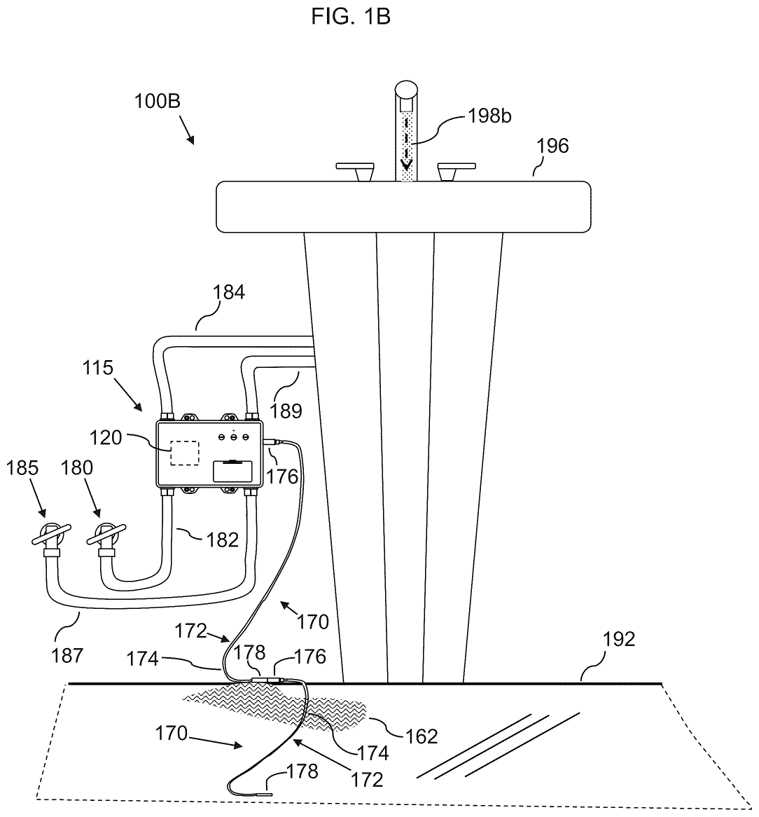

In the following, we describe the structure of an embodiment of a leak control system 100A, 100B including a leak control device 110, 115, with reference to FIGS. 1A and 1B, in such manner that like reference numerals refer to like components throughout; a convention that we shall employ for the remainder of this specification.

In various related embodiments, the leak control system 100A, 100B, 200 includes a leak control device 110, 115 for leak detection and prevention with integrated water flow measurement and physical water detection, for use in domestic and industrial water supply systems. The leak control device 110, 115 is designed for easy installation in water supply lines with capability of detecting water leaks through both flow monitoring and physical water detection. The leak control device 110, 115 automatically shuts off the water supply upon detecting a leak and can report water usage. It is battery-powered, requires no professional installation, and can operate independently or integrate with a smart home system. The leak control device 110, 115 can be used for plumbing fixture applications and other water supply systems, including toilets, sinks with hot and cold water lines, and washing machines.

In further related embodiments, the leak control device 110, 115 is designed to be installed before a toilet tank water supply. It monitors water flow and uses a built-in algorithm to detect leaks based on running water time per instance and cumulative daily usage. Additionally, it includes a 3-feet long detection cable to identify physical water leaks on the ground. Upon detecting a potential leak, the leak control device 110, 115 automatically shuts off the water supply to prevent water damage and reports water usage.

In an embodiment, as shown in FIG. 1A, a leak control system 100A can include:
a) A water supply line 180;
b) A toilet 194 (or other single-water-line water appliance, such as a dishwasher), which is fluidly connected to the water supply line 180; and
c) A single-valve leak control device 110 for leak detection and prevention, wherein the leak control device 110 can include:
   i. a control unit 120;
   ii. a first/single flow control assembly 332;
      1) a valve assembly 340, including:
         a valve 344, which can be a mechanical valve and be configured as a shut-off valve; and
         an electro-mechanical actuator 342, which can for example be an electric motor or linear actuator, wherein the electro-mechanical actuator 342 is mechanically connected to the valve 344, such that the electro-mechanical actuator 342 is configured to control opening and closing of the valve 344;
      2) a flow sensor 350;
   iii. at least one cable assembly 170, including:
      3) a leak detector cable 172, which comprises:
         a leak sensor 174, which can be configured along a length of the leak detector cable 172, such that the leak sensor 174 is configured to detect a presence of water 162, 362 on a floor surface 192 adjacent to the toilet 194, such that the leak sensor issues a leak indication 352 when the leak sensor 174 detects the presence of the water 162, 362;
      4) a first connector 176, which is connected to a first end of the leak detector cable 172, such that the first end of the leak detector cable 172 is configured to connect to the control unit 120 via a receiving port of the single-valve leak control device 110; and
      5) a second connector 178, which is connected to a second end of the leak detector cable 172, such that the second connector 178 is configured to connect to a first connector 176 of a second cable assembly 170, to enable series extension of a plurality of cable assemblies 170, as shown in FIG. 1B;
wherein the leak control device 110 is fluidly connected to the water supply line 180 between an initial segment 182 and a secondary segment 184 of the water supply line 180, such that the flow sensor 350 is configured to measure a flow 364 of water 362 through the first/single flow control assembly 332 of the leak control device 110;
wherein the leak control device 110 can be configured to close the valve 344, to stop the flow 364 of the water 362 through the leak control device 110 and to the toilet 194, if the leak control device 110 receives the leak indication 352 from the leak sensor 174 or (i.e., inclusive or, either or both) detects a flow anomaly condition in communication with the flow sensor 350.

In a related embodiment, the leak detector cable assembly 170 can be for example be configured as a 3-foot or 10-foot cable. The second connector 178 can be configured as a female phone jack connector, and the first connector 176 can be configured as a male phone jack connector, which can be connected to a female input port on a main device body of the leak control device 110. Several leak detector cable assemblies 170 can also be connected in series to cover a larger area, such as in a laundry room where 2 or 3 cables might be needed. In general, a plurality of leak detector cable assemblies can be connected in series to extend up to 100 feet. In some embodiments the leak sensor 174 can be positioned on an outer end of the leak detector cable 172.

In a related embodiment, a control unit 120 can include:
a) A processor 302;
b) A non-transitory memory 304;
c) An input/output component 306;
d) A leak detection manager 310; all connected via
e) A data bus 318;
such that the control unit 120 can be communicatively connected to the flow sensor 350, the valve 344 (via a connection to the electro-mechanical actuator 342 of the valve assembly 340), and the leak sensor 174 of the leak detector cable 172;
wherein the leak detection manager 310 can be configured to close the valve 344, to stop the flow 364 of the water 362 through the leak control device 110 and to the toilet 194, if the leak detection manager 310 receives a leak indication 352 from the leak sensor 174 or (i.e., inclusive or, either or both) detects a flow anomaly condition in communication with the flow sensor 350.

In further related embodiments, the leak control device 110 can be configured such that:
a) The control unit 120 can be configured with a predetermined maximum flow duration of a water flow 364 for each water flow event 198a, 198b (i.e. an even of water use such as refilling toilet after flushing or faucet running), such that:
   i. the control unit 120 can be configured to measure an actual flow duration of the water flow event 198a, 198b in communication with the flow sensor 350, such that the actual flow duration can be viewed on a connected personal communication device 220;
   ii. the predetermined maximum water flow duration can default to 5 minutes; and
   iii. wherein the control unit 120 can be configured such that if the actual flow duration exceeds the predetermined maximum flow duration, the control unit 120 is configured to set the flow anomaly condition and close the valve automatically;
b) The control unit 120 can be configured with a predetermined maximum flow quantity of a water flow 364 for each water flow event 198a, 198b, such that:
   i. the control unit 120 can be configured to measure an actual flow quantity of a water flow 364 of the water flow event 198a, 198b, in communication with the flow sensor 350, such that the actual flow quantity for each water flow event can be viewed on a connected personal communication device 220;
   ii. wherein the predetermined maximum flow quantity can for example default to 5 gallons; and
   iii. wherein the control unit 120 can be configured such that if an actual flow quantity exceeds the predetermined maximum flow quantity, the control unit 120 can be configured to set the flow anomaly condition and close the valve 344 automatically; and
c) The control unit 120 can be configured with a predetermined maximum daily water usage of a total water flow 364 during a 24-hour day, such that:
   i. the control unit 120 can be configured to measure an actual daily water usage in communication with the flow sensor 350, such that the actual daily water usage can be viewed on a connected personal communication device 220;
   ii. wherein the predetermined maximum daily water usage can for example default to 30 gallons;
   iii. wherein the control unit can be configured such that if an actual daily water usage exceeds the predetermined maximum daily water usage, the control unit 120 can be configured to set the flow anomaly condition and close the valve 344 automatically;
d) The control unit 120 can be configured with a predetermined maximum number of daily water flow events 198a, 198b (i.e. toilet flushes, faucet open, etc.) during a 24-hour day, such that:
   i. the control unit 120 can be configured to count an actual number of daily water flow events in communication with the flow sensor 350, such that the actual number of daily water flow events can be viewed on a connected personal communication device 220;
   ii. wherein the predetermined maximum number of daily water flow events can for example default to 20;
   iii. wherein the control unit 120 is configured such that if an actual number of daily water flow events exceeds the predetermined maximum number of daily water flow events, the control unit 120 can be configured to set the flow anomaly condition and close the valve 344 automatically; and
e) The control unit 120 can be configured, such that manually opening the valve 344 or opening the valve 344 via the personal communication device 220 after the valve was closed causes a reset to zero of for aggregated values for actual daily usage and actual number of daily water flow events.

In an embodiment, as shown in FIG. 1B, a leak control system 100B can include:
a) a first water supply line 180 (for example the cold water supply line), which can include a first initial segment 182 and a first secondary segment 184;
b) a second water supply line 185 (for example the hot water supply line), which can include a second initial segment 187 and a second secondary segment 189;
c) A dual-water-line plumbing fixture 196 (such as a kitchen sink with faucet for hot and cold water), which is fluidly connected to each of the first water supply line 180 and the second water supply line 185; and
d) A dual-valve leak control device 115 for leak detection and prevention, wherein the dual-valve leak control device 115 can include:
   i. a control unit 120;
   ii. a first flow control assembly 332, which can include:
      1) a first valve assembly 340, including:
         a first valve 344; and
         a first electro-mechanical actuator 342, which can for example be an electric motor or linear actuator, wherein the first electro-mechanical actuator 342 is mechanically connected to the first valve 344, such that the first electro-mechanical actuator 342 is configured to control opening and closing of the first valve 344; and
      2) a first flow sensor 350;
      wherein the first flow control assembly 332 is fluidly connected to the first water supply line 180 between a first initial segment 182 and a first secondary segment 184 of the water supply line 180, such that the first flow sensor 350 is configured to measure a first flow 364 of water 362 through the first flow control assembly 332 of the leak control device 110;
      such that the control unit 120 can be communicatively connected to the first flow sensor 350, the first valve 344 (via a first communicative connection to the first electro-mechanical actuator 342 of the valve assembly 340), and the leak sensor 174 of the leak detector cable 172;
      wherein the leak control device 110 can be configured to close the first valve 344, to stop the first flow 364 of the water 362 through the first flow control assembly 332 of the leak control device 110 and to the dual-water-line plumbing fixture 196, if the leak control device 110 receives a leak indication 352 from the leak sensor 174 or (i.e., inclusive or, either or both) detects a first flow anomaly condition of the first flow control assembly in communication with the first flow sensor 350; and
   iii. a second flow control assembly 334, which can include:
      1) a second valve assembly 341, including:
         a second valve 345; and
         a second electro-mechanical actuator 343, which can for example be an electric motor or linear actuator, wherein the second electro-mechanical actuator 343 is mechanically connected to the second valve 345, such that the second electro-mechanical actuator 343 is configured to control opening and closing of the second valve 345; and
      2) a second flow sensor 351;
      wherein the second flow control assembly 334 is configured to be fluidly connected to the second water supply line 185 between a second initial segment 187 and a second secondary segment 189 of the second water supply line 185, such that the second flow sensor 351 is configured to measure a second flow 365 of water 363 through the second flow control assembly 334 of the leak control device 110;
      such that the control unit 120 can be further communicatively connected to the second flow sensor 351, the second valve 345 (via a second communicative connection to the second electro-mechanical actuator 343 of the valve assembly 340);
      wherein the leak control device 110 can be configured to close the second valve 345, to stop the second flow 365 of the water 363 through the second flow control assembly 334 of the leak control device 110 and to the dual-water-line plumbing fixture 196, if the leak control device 110 receives a leak indication 352 from the leak sensor 174 or (i.e., inclusive or, either or both) detects a second flow anomaly condition of the second flow control assembly 334 in communication with the second flow sensor 351; and
   iv. a leak detector cable 172, including a leak sensor 174, which can be configured along a length of the leak detector cable 172, such that the leak sensor 174 is configured to detect a presence of water on a floor surface 192 adjacent to the toilet 194;
   wherein the leak control device is configured to close the first valve 344 and the second valve 345, to stop a combined flow of the water through the leak control device 115 (i.e., the sum of the flow through the first flow control assembly 332 and the flow through the second flow control assembly 334), if the leak control device receives the leak indication 352 from the leak sensor 174.

In a further related embodiment, the leak detection manager 310 of the control unit 120 can be configured to close the first valve 344 and close the second valve 345, to stop the combined flow of the water through the leak control device 115, if the leak detection manager receives 310 the leak indication 352 from the leak sensor 174 or detects the first flow anomaly condition or detects the second flow anomaly condition in communication with the first flow sensor 350 and the second flow sensor 351, respectively.

In further related embodiments, the dual-valve leak control device 115 can be configured such that:
a) The control unit 120 can be configured with a predetermined maximum flow duration of a water flow 364, 365 for each water flow event 198a, 198b (i.e. an event of water use such as refilling toilet after flushing or faucet running) of at least one of the first flow control assembly 332 and the second flow control assembly 334, such that:
   i. the control unit 120 can be configured to measure an actual flow duration of the water flow event 198a, 198b in communication with the first flow sensor 350 and the second flow sensor 351, such that the actual flow duration can be viewed on a connected personal communication device 220;
   ii. the predetermined maximum water flow duration can default to 5 minutes; and
   iii. wherein the control unit 120 can be configured such that if the actual flow duration exceeds the predetermined maximum flow duration, the control unit 120 is configured to set the flow anomaly condition and close the first valve 344 and the second valve 345 automatically;
b) The control unit 120 can be configured with a predetermined maximum flow quantity of a water flow 364, 365 for each water flow event 198a, 198b of at least one of the first flow control assembly 332 and the second flow control assembly 334, such that:
   i. the control unit 120 can be configured to measure an actual flow quantity of a water flow 364, 365 of the water flow event, in communication with the first flow sensor 350 and the second flow sensor 351, such that the actual flow quantity for each water flow event can be viewed on a connected personal communication device 220;
   ii. wherein the predetermined maximum flow quantity can for example default to 5 gallons; and
   iii. wherein the control unit 120 can be configured such that if an actual flow quantity exceeds the predetermined maximum flow quantity, the control unit 120 can be configured to set the flow anomaly condition and close the first valve 344 and the second valve 345 automatically; and
c) The control unit 120 can be configured with a predetermined maximum daily water usage of a total water flow 364, 365 of the first flow control assembly 332 and the second flow control assembly 334 during a 24-hour day, such that:
   i. the control unit 120 can be configured to measure an actual daily water usage in communication with the first flow sensor 350 and the second flow sensor 351, such that the actual daily water usage can be viewed on a connected personal communication device 220;
   ii. wherein the predetermined maximum daily water usage can for example default to 30 gallons;
   iii. wherein the control unit can be configured such that if an actual daily water usage exceeds the predetermined maximum daily water usage, the control unit 120 can be configured to set the flow anomaly condition and close the first valve 344 and the second valve 345 automatically;
d) The control unit 120 can be configured with a predetermined maximum number of daily water flow events 198a, 198b of the first flow control assembly 332 and the second flow control assembly 334 (i.e. toilet flushes, cold/warm faucet open, etc.) during a 24-hour day, such that:
   i. the control unit 120 can be configured to count an actual number of daily water flow events in communication with the first flow sensor 350 and the second flow sensor 351, such that the actual number of daily water flow events can be viewed on a connected personal communication device 220;
   ii. wherein the predetermined maximum number of daily water flow events can for example default to 20;
   iv. wherein the control unit 120 is configured such that if an actual number of daily water flow events exceeds the predetermined maximum number of daily water flow events, the control unit 120 can be configured to set the flow anomaly condition and close the first valve 344 and the second valve 345 automatically;
e) The control unit 120 can be configured, such that manually opening the valve 344 or opening the valve 344 via the personal communication device 220 after the valve was closed causes a reset to zero of for aggregated values for actual daily usage and actual number of daily water flow events.

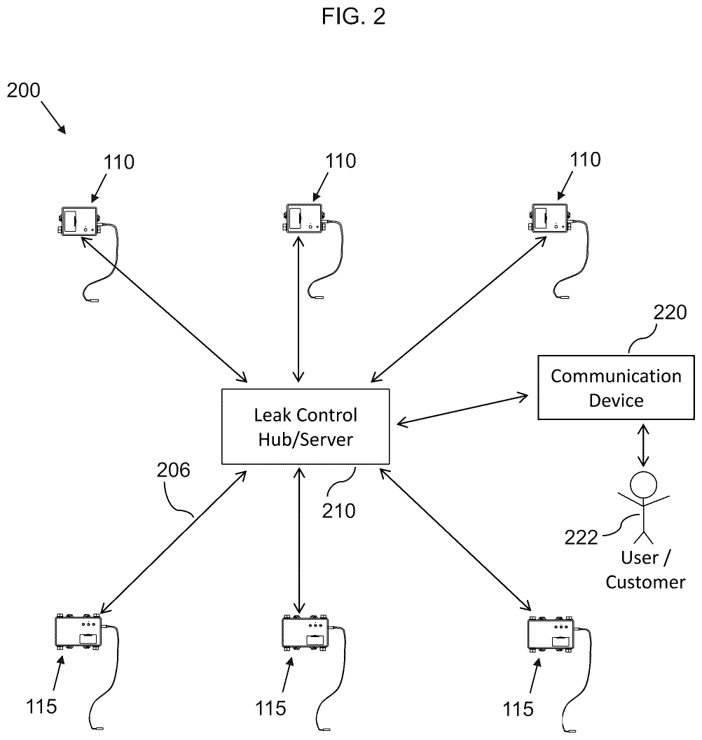

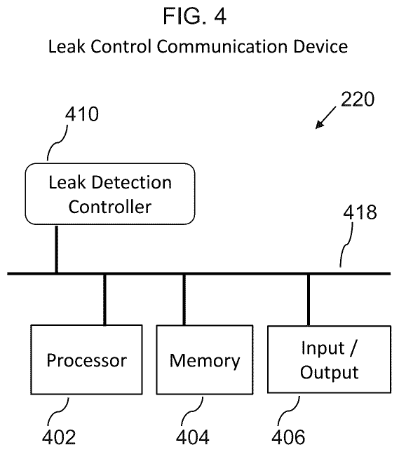

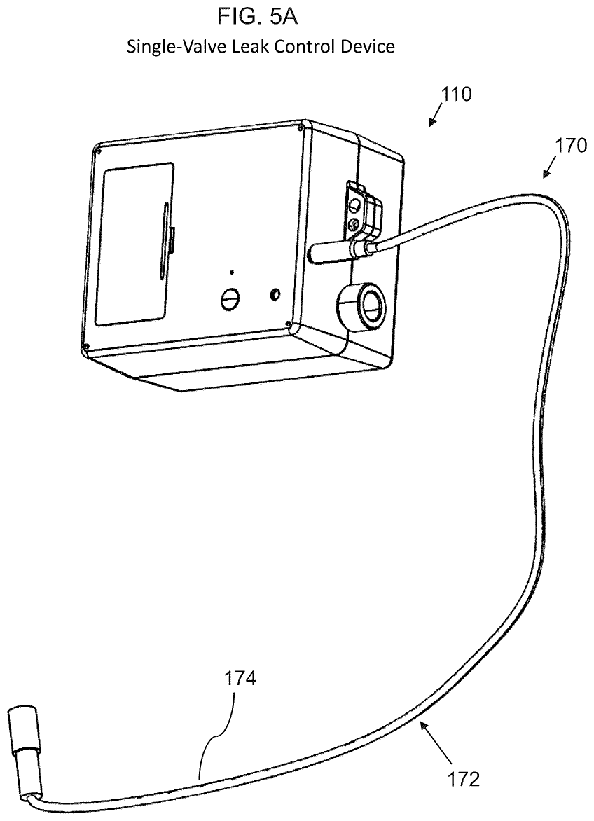

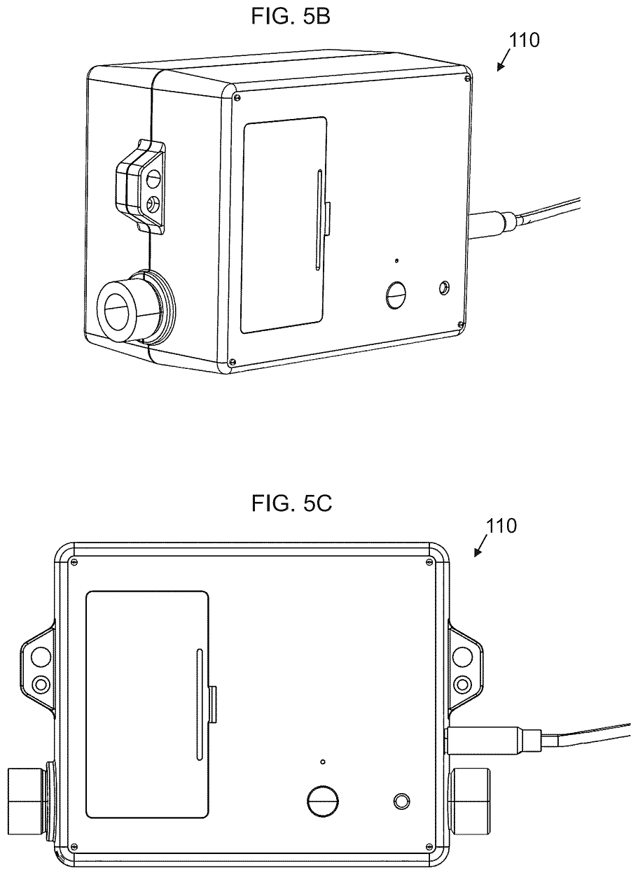

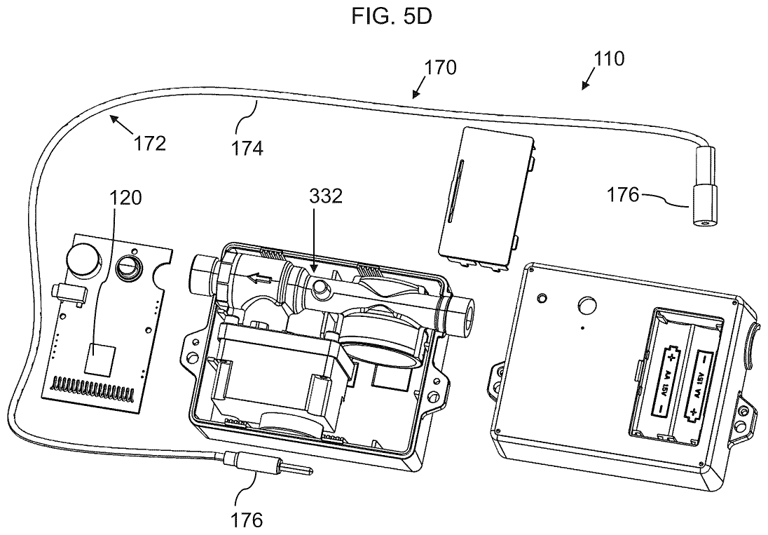

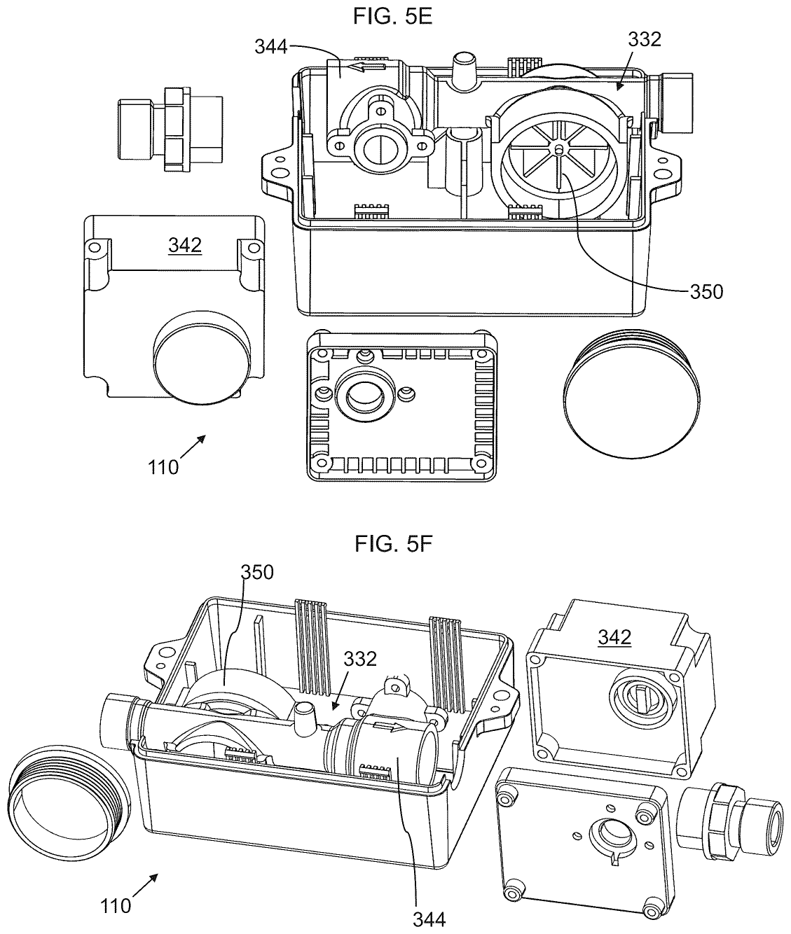

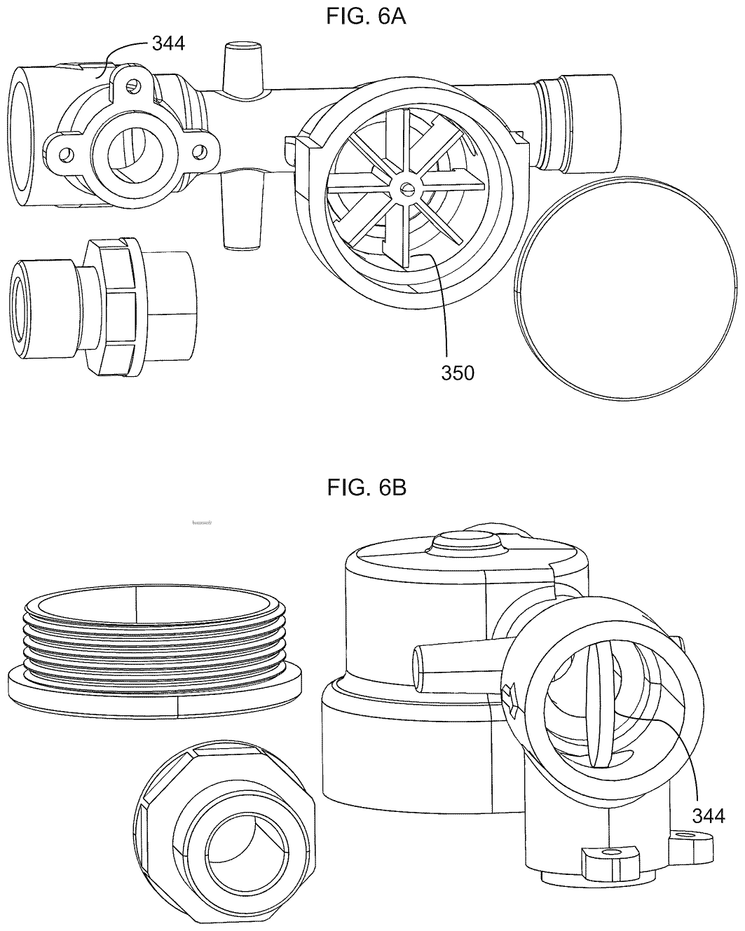

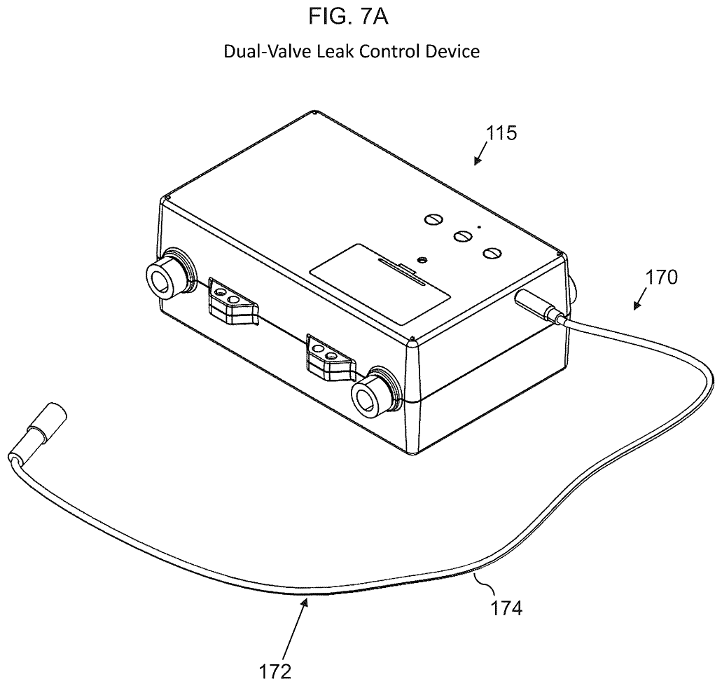

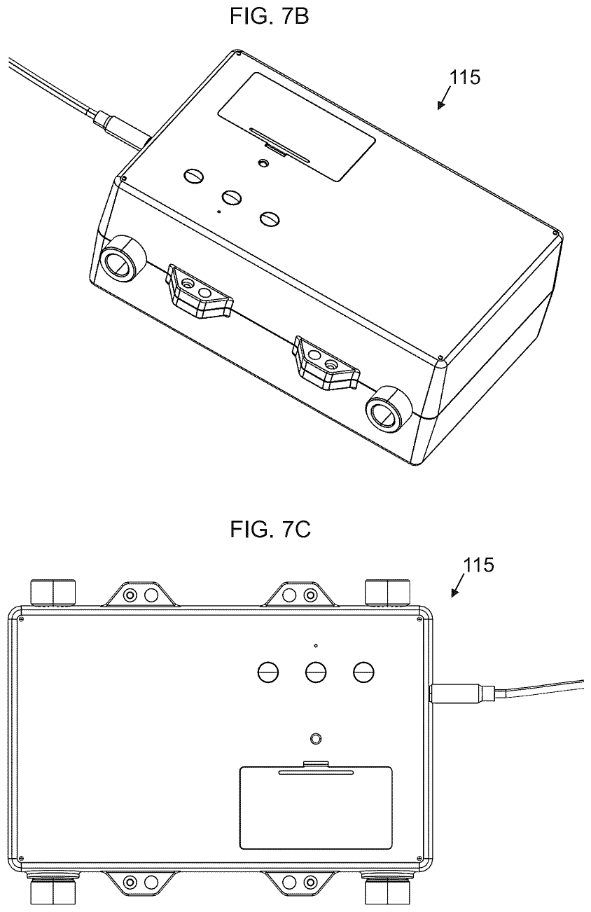

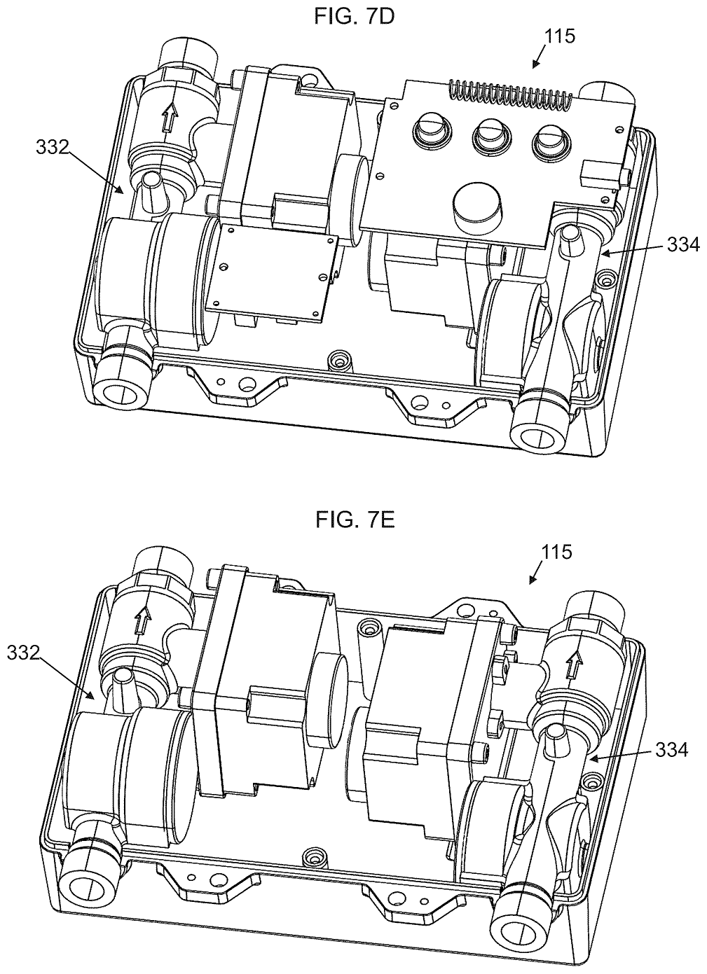

In a related embodiment, as shown in FIGS. 2 and 4, a leak control system 200 can include:
a) A plurality of single-valve leak control devices 110;
b) A plurality of dual-valve leak control devices 115; and
c) A leak control server 210; and
d) A personal leak control communication device 220;
wherein the leak control server 210 can be connected to the single-valve leak control devices 110 and the dual-valve leak control devices 115 via a network 206, which can be a wireless network;
wherein the personal leak control communication device 220 is configured to process user input and display system information in communication with control units of single-valve leak control devices 110 and dual-valve leak control devices 115, either directly or via the leak detection hub/server 210.

In a further related embodiment, the network 206 can be a long-range and low-power consumption (LoRa) wireless network, such as the network and associated network protocols described in U.S. Pat. No. 11,089,545, issued 2021 Aug. 10, and titled “System and method for low power data transmission and control”; which is hereby incorporated herein by reference in its entirety.

In yet a further related embodiment, as shown in FIGS. 2 and 4, a personal communication device 220 can include:
e) a plurality of processor 402;
f) A non-transitory memory 404;
g) An input/output 406; and
h) A leak detection controller 410; all connected via
i) A data bus 418;
wherein the leak detection controller 410 is configured to process user input and display system information in communication with control units of single-valve leak control devices 110 and dual-valve leak control devices 115, either directly or via a leak detection hub/server 210, as shown in FIG. 2.

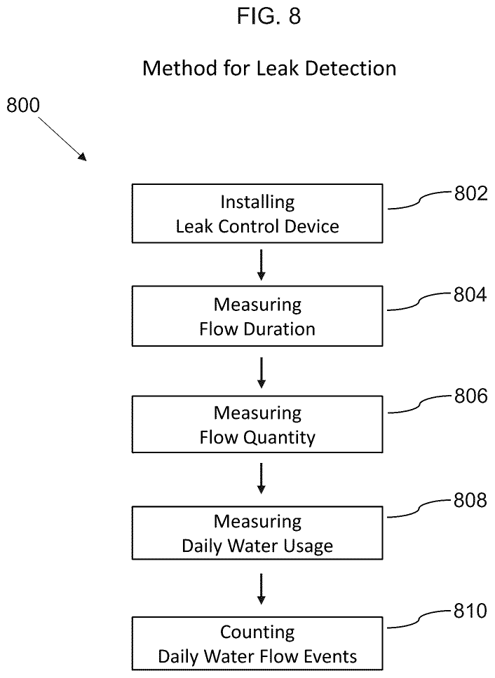

In an embodiment, as illustrated in FIG. 8, a method for leak control 800, can include:
a) Installing 802 a leak control device 115 on a plumbing fixture 194, 196;
b) Measuring 804 an actual flow duration of water flow events 198a, 198b in communication with a flow sensor 350 of the leak control device 115, such that if the actual flow duration exceeds the predetermined maximum flow duration, the control unit 120 is configured to set the flow anomaly condition and close the valve automatically;
c) Measuring 806 an actual flow quantity of a water flow 364 of the water flow event 198a, 198b, in communication with the flow sensor 350, such that if an actual flow quantity exceeds the predetermined maximum flow quantity, the control unit 120 can be configured to set the flow anomaly condition and close the valve 344 automatically;
d) Measuring 808 an actual daily water usage in communication with the flow sensor 350,
   such that if an actual daily water usage exceeds the predetermined maximum daily water usage, the control unit 120 can be configured to set the flow anomaly condition and close the valve 344 automatically;
e) Counting 810 an actual number of daily water flow events in communication with the flow sensor 350,
   such that if an actual number of daily water flow events exceeds the predetermined maximum number of daily water flow events, the control unit 120 can be configured to set the flow anomaly condition and close the valve 344 automatically.

In a further related embodiment, the leak control device 110 can further include:
a) An Inlet Port, which can be configured with a ⅜″ external thread;
b) An Outlet Port, which can be configured with ⅜″ external thread;
f) Impeller Flow Meter, which can be connected to the main PCB board via a 3-pin connector. The expected accuracy is up to 5%, with a starting flow rate of 8 L/hr. The flow meter can alternatively be configured as a pulse water meter, or can be configured as a mechanical, ultrasonic, electromagnetic, and/or vortex flow meter. The flow meter can be configured to provide high and low signal levels via a Hall sensor;
c) A Water Immersion Detection Line Input;
d) A Buzzer Alarm;
e) An Electric Valve Actuator, which can be connected to the main PCB board via a 5-pin connector;
f) A power supply, which can be configured as two AA Alkaline Batteries;
g) A control Button;
h) Indicator Lights, which can be Red and Green;
g) A Battery Cover;
h) A front body shell portion;
i) A rear body shell portion;
j) An Electric Valve Actuator;
k) A Valve;
l) An Antenna, for providing a signal to the wireless communication module; and
m) Mounting screws.

In another related embodiment, installation of the leak control device 110 can include:
a) Loosening an existing water supply hose;
b) Connecting a new hose assembly: such that a first end is end is connected the to the water supply valve, and a second end is connected to the leak control device 110;
c) Connecting a first end of the original hose to the toilet valve control device outlet connection and connection a second end of the original hose to the toilet; and
d) Mount the device on an adjoining wall.

In related embodiments, the leak control device 110 is configured with an advanced smart leak detection system, which measures the water flow and calculates the amount of water usage and running time per instance. Additionally, the leak control device 110 tracks the number of flushes within a 24-hour period, which can detect running toilets and over-flushing due to toilet malfunctions. This feature addresses a significant source of water waste in the US, and thus offers a substantial environmental benefit. The leak control device 110 is uniquely designed to operate on 2 AA batteries, providing up to 5 years of operation. Furthermore, the leak control device 110 leverages a proprietary LoRa wireless protocol, ensuring the longest-range wireless communication available. The dual-valve leak control device 115 can be used in the laundry room and kitchen or bathroom sinks, and includes 2 shutoff valves and 2 flow sensors built in, with a longer sensor cable to detect external water leaks. If a leak is detected, both valves for hot and cold water will be shut off.

In related embodiments, the leak control device 110 can include:
a) Housing: A waterproof enclosure that houses the internal components.
b) Flow Sensor(s): Detects the flow of water through the supply line(s). For toilets, a single flow sensor is used; for sinks, dual flow sensors are employed to monitor both hot and cold water lines.
c) Control Unit: Processes data from the flow sensor(s) and the detection cable to determine if a leak is present.
d) Shutoff Valve(s): Mechanically closes the water supply line(s) upon detection of a leak. For toilets, a single valve is used; for sinks, dual motorized valves are employed.
e) Power Supply: Powered by 2 AA batteries, providing up to 5 years of operation.
f) Communication Module: Incorporates a LoRa chip for long-range communication with the leak control hub server 210, enabling remote monitoring and alerts.
g) Detection Cable: A 3-feet long cable with a phone jack connection, designed to detect physical water presence on the ground.
h) Installation Cables and Connectors, including:
   i. A one-foot flexible ⅜-inch female-to-female cable for easy installation in toilet applications;
   ii. In and out ⅜-inch male connectors for toilet applications;
   iii. Adapters (⅜ inches to ¼ inch or ½ inch) for compatibility with various water supply applications such as sinks, refrigerator water supply, dishwashers, and washing machines; and
   iv. Dual input and output connectors for hot and cold water lines in sink applications.

In related embodiments, the leak control device 110 can be designed for tool-free installation. The device is mounted on the water supply line(s), secured with hand-tightened connectors. The detection cable is plugged into the device and laid on the ground to detect water leaks. Adapters allow for installation in other water supply systems. No professional plumbing or electrical work is required, making it accessible for DIY installation.

In other related embodiments, operation modes of the leak control device 110, 115 can include:
a) Normal Detection Mode: The flow sensor(s) continuously monitors water usage. Data is sent to the control unit, which records the duration and frequency of water flow events. The detection cable monitors for physical water leaks on the ground;
b) Leak Alert Mode: If the control unit detects an anomaly, such as continuous flow beyond typical usage patterns or physical water detected by the cable, it activates the shutoff valve(s) to stop the water supply. An alert is sent to the user 222 via the personal communication device 220 of the leak control system 200, if connected. The device also reports water usage for each application; and
c) Battery Monitoring: The device includes a low-battery indicator that alerts the user to replace the batteries, ensuring uninterrupted operation.

In further related embodiment, when used with a leak detection smart home system 200, the device parameters can be configured through the personal leak control communication device 220. Users can set maximum running time per instance and maximum water usage per day. Default values are provided for standalone operation. Customers with an installed leak control server 210 and leak detection smart home system 200 can modify these parameters to suit different use cases via the personal leak control communication device 220.

Thus, in various related embodiments, the leak control system 100 can include:
a) A leak detection and prevention device comprising:
   i. A housing configured to be installed on a water supply line;
   ii. A flow sensor disposed within the housing to detect water flow;
   iii. A control unit within the housing, configured to receive data from the flow sensor and a detection cable to determine the presence of a leak based on predefined criteria;
   iv. A shutoff valve controlled by the control unit, configured to close the water supply line upon detection of a leak;
   v. A power supply comprising 2 AA batteries, configured to provide power to the device for up to 5 years;
   vi. A communication module incorporating a LoRa chip, configured to connect the device to a smart home system, enabling remote monitoring and alerts;
   vii. A detection cable connected to the device via a phone jack connection, designed to detect physical water presence on the ground;
   viii. In and out ⅜ inch male connectors on the housing, and a one-foot flexible ⅜ inch female-to-female cable for easy installation between the water supply valve and the toilet connector;
   ix. Adapters for converting the ⅜ inch connectors to ¼ inch or ½ inch connectors, allowing compatibility with various water supply applications such as sinks, refrigerator water supply, dishwashers, and washing machines;
   x. Dual input and output connectors, dual flow sensors, and dual motorized valves for applications requiring monitoring of both hot and cold water lines.
b) The device of a), wherein the predefined criteria for detecting a leak include:
   i. Running water time per instance exceeding a threshold value;
   ii. Number of daily flushes exceeding a threshold value;
   iii. Cumulative daily water usage exceeding a threshold value; and
   iv. Physical water presence detected by the detection cable;
c) The device of a), further comprising:
   i. A low-battery indicator configured to alert the user when the power supply needs replacement.
d) The device of claim a, wherein the communication module is configured to enable the device to operate independently or as part of a smart home system.
e) The device of a), further configured to report water usage for each application to the user through the smart home system.
f) The device of a), wherein the communication module uses LoRa wireless technology to send alert messages and report data to the leak control server 210 from long communication ranges.
g) The device of a), wherein the parameters such as maximum running time per instance and maximum water usage per day can be set and modified through a smart home system application, with default values provided for standalone operation.

In related embodiments, the leak control communication device 220 can include configurations as:
a) A web application, executing in a Web browser;
b) A tablet app, executing on a tablet device, such as for example an ANDROID™ or IOS™ tablet device;
c) A mobile app, executing on a mobile device, such as for example an ANDROID™ phone or IPHONE™, or any wearable mobile device;
d) A desktop application, executing on a personal computer, or similar device;
e) An embedded application, executing on a processing device, such as for example a smart TV, a game console or other system.

It shall be understood that an executing instance of an embodiment of the system for leak control system 200, as shown in FIG. 2, can include a plurality of leak control communication devices 220, which are each tied to one or more users 222.

An executing instance of an embodiment of the system for system for leak control system 200, as shown in FIG. 2, can similarly include a plurality of leak control servers 102.

FIGS. 1A-1B, 2, and 3A-3B, 4, and 8 are block diagrams and flowcharts, methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 1A-1B, 2, 3A-3B, and 4 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random-access memory (RAM) and read-only memory (ROM). The computer also may include nonvolatile storage memory, such as a hard disk drive, where additional data can be stored.

FIG. 2 shows a depiction of an embodiment of the leak control system 200, including the leak control server 210, and the leak control communication device 220. In this relation, a server shall be understood to represent a general computing capability that can be physically manifested as one, two, or a plurality of individual physical computing devices, located at one or several physical locations. A server can for example be manifested as a shared computational use of one single desktop computer, a dedicated server, a cluster of rack-mounted physical servers, a datacenter, or network of datacenters, each such datacenter containing a plurality of physical servers, or a computing cloud, such as AMAZON EC2™ or MICROSOFT AZURE™.

It shall be understood that the above-mentioned components of the leak control server 210 and the leak control communication device 220 are to be interpreted in the most general manner.

For example, the processors 302, 402 can each respectively include a single physical microprocessor or microcontroller, a cluster of processors, a datacenter or a cluster of datacenters, a computing cloud service, and the like.

In a further example, the non-transitory memory 304 and the non-transitory memory 404 can each respectively include various forms of non-transitory storage media, including random access memory and other forms of dynamic storage, and hard disks, hard disk clusters, cloud storage services, and other forms of long-term storage. Similarly, the input/output 306 and the input/output 406 can each respectively include a plurality of well-known input/output devices, such as screens, keyboards, pointing devices, motion trackers, communication ports, and so forth.

Furthermore, it shall be understood that the leak control server 210 and the leak control communication device 220 can each respectively include a number of other components that are well known in the art of general computer devices, and therefore shall not be further described herein. This can include system access to common functions and hardware, such as for example via operating system layers such as WINDOWS™, LINUX™, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In a related embodiment, the leak control communication device 220 communicates with the leak control server 210 over a network 206, which can include the general Internet, a Wide Area Network or a Local Area Network, or another form of communication network, transmitted on wired or wireless connections. Wireless networks can for example include Ethernet, Wi-Fi, BLUETOOTH™, ZIGBEE™, NFC, and proprietary low-power consumption long range wireless networks. The communication can be transferred via a secure, encrypted communication protocol.

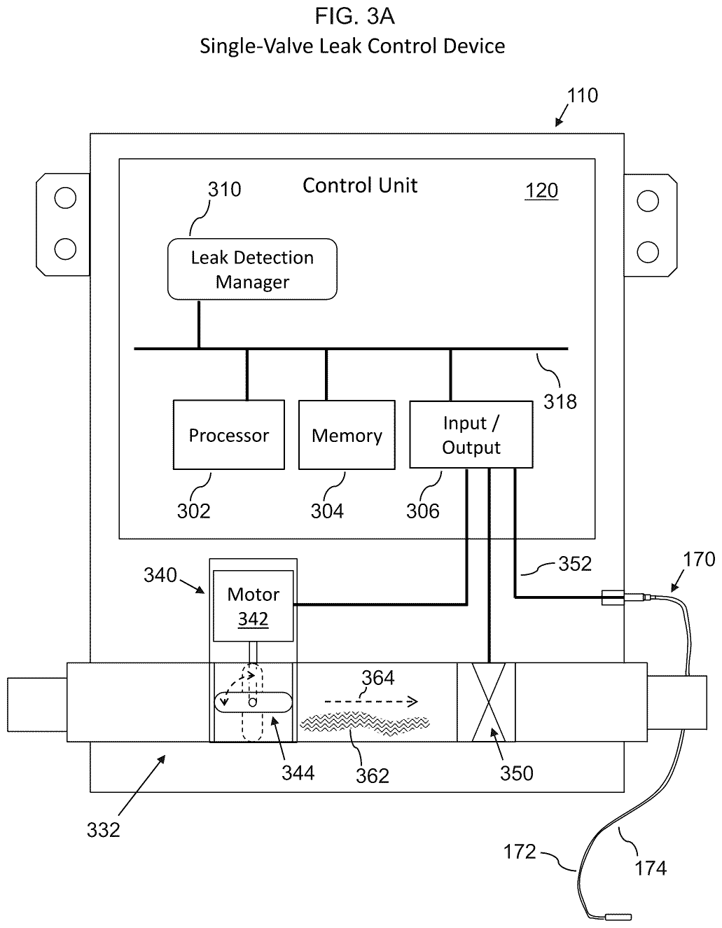

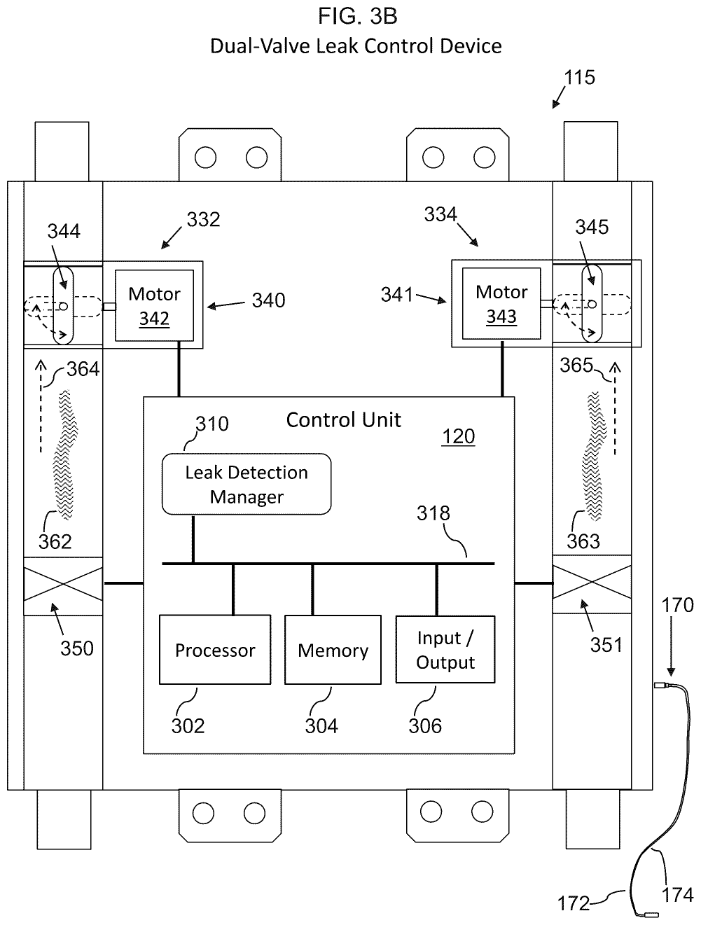

In various related embodiment, as shown in FIGS. 1A-1B, 2, 3A, 3B, and 4, components of the control unit 120, the leak control server 210, and the leak control communication device 220 can include:
a) Software modules 310, 410, which can include the leak detection manager 310 and the leak detection controller 410; wherein the software modules 310, 410 are denoted in FIGS. 3A-3B, and 4 by soft/rounded corner rectangles, and wherein the software modules 310, 410 can be defined by computer program instructions for execution by a processor 302, 402. In some embodiments, parts or all of the software modules 310, 410 can be compiled to hardware, such as field-programmable gate array circuits or other programmable logic hardware; and
b) Hardware components 302, 402, 304, 404, 306, 406, which can for example include a processor 302, 402, a non-transitory memory 304, 404, an input/output component 306, 406, etc.;
   wherein the hardware components 302, 402, 304, 404, 306, 406 are denoted in FIGS. 3A-3B and 4 by hard corner rectangles, and can be defined by circuits in silicone and/or other materials and can be mounted on a circuit board. In some embodiment, parts of the Hardware components 302, 402, 304, 404, 306, 406 can be implemented as computer program instructions, including operating system code, such as BIOS code or microcode of programmable controllers.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

Here has thus been described a multitude of embodiments of the leak control system 100A, 100B, 200, the leak control device 110, 115, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent and should be considered fully included in this specification and the claims appended hereto. Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. A leak control device for leak detection and prevention, comprising:
a flow control assembly, comprising
a valve; and
a flow sensor;
wherein the flow control assembly is configured to connect to a water supply line between an initial segment and a secondary segment of the water supply line, such that the flow sensor is configured to measure a flow of water through the flow control assembly of the leak control device;
wherein the leak control device is configured to close the valve, to stop the flow of the water through the flow control assembly of the leak control device, if the leak control device detects a flow anomaly condition in communication with the flow sensor.

2. The leak control device of claim 1, further comprising:
a valve assembly, comprising:
the valve; and
an electro-mechanical actuator, which is mechanically connected to the valve, such that the electro-mechanical actuator is configured to control opening and closing of the valve.

3. The leak control device of claim 2, wherein the electro-mechanical actuator is an electric motor.

4. The leak control device of claim 1, further comprising:
a cable assembly, which comprises:
a leak detector cable; and
a leak sensor, which is configured along a length of the leak detector cable;
such that the leak sensor is configured to detect a presence of water, such that the leak sensor issues a leak indication when the leak sensor detects the presence of the water;
wherein the leak control device is configured to close the valve, to stop the flow of the water through the leak control device, if the leak control device receives the leak indication from the leak sensor.

5. The leak control device of claim 4, further comprising:
a control unit, which comprises:
a processor;
a non-transitory memory;
an input/output component; and
a leak detection manager;
such that the control unit is communicatively connected to the flow sensor, the valve, and the leak sensor;
wherein the leak detection manager is configured to close the valve, to stop the flow of the water through the leak control device, if the leak detection manager receives the leak indication from the leak sensor or detects the flow anomaly condition in communication with the flow sensor.

6. The leak control device of claim 5, wherein the control unit is configured with a predetermined maximum flow duration of a water flow for each water flow event, such that:
the control unit is configured to measure an actual flow duration of the water flow event in communication with the flow sensor;
wherein the control unit is configured such that if the actual flow duration exceeds the predetermined maximum flow duration, the control unit is configured to set the flow anomaly condition and close the valve automatically.

7. The leak control device of claim 6, wherein the predetermined maximum flow duration is 5 minutes.

8. The leak control device of claim 5, wherein the control unit is configured with a predetermined maximum flow quantity of a water flow for each water flow event, such that:
the control unit is configured to measure an actual flow quantity of the water flow event in communication with the flow sensor;
wherein the control unit is configured such that if the actual flow quantity exceeds the predetermined maximum flow quantity, the control unit is configured to set the flow anomaly condition and close the valve automatically.

9. The leak control device of claim 8, wherein the predetermined maximum flow quantity is 5 gallons.

10. The leak control device of claim 5, wherein the control unit is configured with a predetermined maximum daily water usage of a total water flow, such that:
the control unit is configured to measure an actual daily water usage in communication with the flow sensor;
wherein the control unit is configured such that if the actual daily water usage exceeds the predetermined maximum daily water usage, the control unit is configured to set the flow anomaly condition and close the valve automatically.

11. The leak control device of claim 10, wherein the predetermined maximum daily water usage is 30 gallons.

12. The leak control device of claim 5, wherein the control unit is configured with a predetermined maximum number of daily water flow events, such that:
the control unit is configured to count an actual number of daily water flow events in communication with the flow sensor;
wherein the control unit is configured such that if the actual number of daily water flow events exceeds the predetermined maximum number of daily water flow events, the control unit is configured to set the flow anomaly condition and close the valve automatically.

13. The leak control device of claim 12, wherein the predetermined maximum number of daily water flow events is 20.

14. A leak control device for leak detection and prevention, comprising:
a first flow control assembly, comprising
a first valve; and
a first flow sensor;
wherein the first flow control assembly is configured to connect to a first water supply line between a first initial segment and a first secondary segment of the first water supply line, such that the first flow sensor is configured to measure a first flow of water through the first flow control assembly of the leak control device;
wherein the leak control device is configured to close the first valve, to stop the first flow of the water through the first flow control assembly of the leak control device, if the leak control device detects a first flow anomaly condition of the first flow control assembly in communication with the first flow sensor; and
a second flow control assembly, comprising
a second valve; and
a second flow sensor;
wherein the second flow control assembly is configured to connect to a second water supply line between a second initial segment and a second secondary segment of the second water supply line, such that the second flow sensor is configured to measure a second flow of water through the second flow control assembly of the leak control device;
wherein the leak control device is configured to close the second valve, to stop the second flow of the water through the second flow control assembly of the leak control device, if the leak control device detects a second flow anomaly condition of the second flow control assembly in communication with the second flow sensor.

15. The leak control device of claim 14, further comprising:
a first valve assembly, comprising:
the first valve; and
a first electro-mechanical actuator, which is mechanically connected to the first valve, such that the first electro-mechanical actuator is configured to control opening and closing of the first valve; and
a second valve assembly, comprising:
the second valve; and
a second electro-mechanical actuator, which is mechanically connected to the second valve, such that the second electro-mechanical actuator is configured to control opening and closing of the second valve.

16. The leak control device of claim 14, further comprising:
a cable assembly, which comprises:
a leak detector cable; and
a leak sensor;
such that the leak sensor is configured to detect a presence of the water on a floor surface adjacent to a plumbing fixture, such that the leak sensor issues a leak indication when the leak sensor detects the presence of the water;
wherein the leak control device is configured to close the first valve and the second valve, to stop a combined flow of the water through the leak control device, if the leak control device receives the leak indication from the leak sensor.

17. The leak control device of claim 16, further comprising:
a control unit, which comprises:
a processor;
a non-transitory memory;
an input/output component; and
a leak detection manager;
such that the control unit is communicatively connected to the first valve, the second valve, and the leak sensor;
wherein the leak detection manager is configured to close the first valve and close the second valve, to stop the combined flow of the water through the leak control device, if the leak detection manager receives the leak indication from the leak sensor or detects the first flow anomaly condition or detects the second flow anomaly condition in communication with the first flow sensor and the second flow sensor, respectively.

18. The leak control device of claim 17, wherein the control unit is configured with a predetermined maximum flow duration of a water flow for each water flow event of at least one of the first flow control assembly and the second flow control assembly, such that:
the control unit is configured to measure an actual flow duration of the water flow event in communication with the first flow sensor and the second flow sensor;
wherein the control unit is configured such that if the actual flow duration exceeds the predetermined maximum flow duration, the control unit is configured to set the flow anomaly condition and close the first valve and the second valve automatically.

19. The leak control device of claim 18, wherein the predetermined maximum flow duration is 5 minutes.

20. The leak control device of claim 17, wherein the control unit is configured with a predetermined maximum flow quantity of a water flow for each water flow event of at least one of the first flow control assembly and the second flow control assembly, such that:
the control unit is configured to measure an actual flow quantity of the water flow event in communication with the first flow sensor and the second flow sensor;
wherein the control unit is configured such that if the actual flow quantity exceeds the predetermined maximum flow quantity, the control unit is configured to set the flow anomaly condition and close the first valve and the second valve automatically.

21. The leak control device of claim 20, wherein the predetermined maximum flow quantity is 5 gallons.

22. The leak control device of claim 17, wherein the control unit is configured with a predetermined maximum daily water usage of a total water flow of the first flow control assembly and the second flow control assembly, such that:
the control unit is configured to measure an actual daily water usage in communication with the first flow sensor and the second flow sensor;
wherein the control unit is configured such that if the actual daily water usage exceeds the predetermined maximum daily water usage, the control unit is configured to set the flow anomaly condition and close the first valve and the second valve automatically.

23. The leak control device of claim 22, wherein the predetermined maximum daily water usage is 30 gallons.

24. The leak control device of claim 23, wherein the control unit is configured with a predetermined maximum number of daily water flow events of the first flow control assembly and the second flow control assembly, such that:
the control unit is configured to count an actual number of daily water flow events in communication with the first flow sensor and the second flow sensor;
wherein the control unit is configured such that if the actual number of daily water flow events exceeds the predetermined maximum number of daily water flow events, the control unit is configured to set the flow anomaly condition and close the first valve and the second valve automatically.

25. The leak control device of claim 24, wherein the predetermined maximum number of daily water flow events is 20.

26. A leak control method for leak detection and prevention, comprising:
a) installing a leak control device on a plumbing fixture; and
b) measuring an actual flow duration of water flow events in communication with a flow sensor of the leak control device,
such that if the actual flow duration exceeds a predetermined maximum flow duration, the leak control device sets a flow anomaly condition and close a valve of the leak control device automatically;
wherein the leak control device comprises:
a flow control assembly, comprising
the valve; and
the flow sensor;
wherein the flow control assembly is configured to connect to a water supply line between an initial segment and a secondary segment of the water supply line, such that the flow sensor is configured to measure a flow of water through the flow control assembly of the leak control device;
wherein the leak control device is configured to close the valve, to stop the flow of the water through the flow control assembly of the leak control device, if the leak control device detects the flow anomaly condition in communication with the flow sensor.

27. The leak control method of claim 26, further comprising:
measuring an actual flow quantity of a water flow of a water flow event, in communication with the flow sensor,
such that if the actual flow quantity exceeds a predetermined maximum flow quantity, the leak control device sets the flow anomaly condition and closes the valve automatically.

28. The leak control method of claim 26, further comprising:
measuring an actual daily water usage in communication with the flow sensor, such that if the actual daily water usage exceeds a predetermined maximum daily water usage, the leak control device sets the flow anomaly condition and closes the valve automatically.

29. The leak control method of claim 26, further comprising:
counting an actual number of daily water flow events in communication with the flow sensor,
such that if the actual number of daily water flow events exceeds a predetermined maximum number of daily water flow events, the leak control device sets the flow anomaly condition and closes the valve automatically.
